(19) United States
(12) Patent Application Publication
(10) Pub. No.: US 2004/0006583 A1
(43) Pub. Date: Jan. 8, 2004

(54) Method and apparatus for converting a synchronized method into a non-synchronized method

(76) Inventors: Nicholas Shaylor, Sunnyvale, CA (US); Douglas N. Simon, Mountain View, CA (US)

Correspondence Address: PARK, VAUGHAN & FLEMING LLP, 508 SECOND STREET, SUITE 201, DAVIS, CA, 95616, US

(21) Appl. No.: 10/456,351

(22) Filed: Jun. 6, 2003

Related U.S. Application Data
(60) Provisional application No. 60/392,375, filed on Jun. 26, 2002.
(60) Provisional application No. 60/412,607, filed on Sep. 20, 2002.

(51) Int. Cl. G06F 9/00

(52) U.S. Cl. 709/102

(57) ABSTRACT

One embodiment of the present invention provides a system that facilitates converting a synchronized method into a non-synchronized method. During operation, the system receives a code module that includes a synchronized method. This synchronized method automatically performs a lock operation before executing its method body and automatically performs an unlock operation after executing its method body, whereby at most one thread at a time can execute the method body. Next, the system changes the synchronized method into a non-synchronized method that does not automatically perform lock and unlock operations. The system also inserts an explicit lock instruction at the beginning of the method body, and inserts an explicit unlock instruction at the end of the method body.

### RELATED APPLICATION

This application hereby claims priority under 35 U.S.C. §119 to U.S. Provisional Patent Application No. 60/392,375, filed on Jun. 26, 2002, entitled “Optimizing Platform Independent Code,” by inventors Nicholas Shaylor and Douglas Simon and to U.S. Provisional Patent Application No. 60/412,607, filed on Sep. 20, 2002, entitled “The Squawk System,” by inventors Nicholas Shaylor and Douglas Simon.

### BACKGROUND

1. Field of the Invention

The present invention relates synchronization operations within programming languages. More specifically, the present invention relates to a method and an apparatus for converting a synchronized method into a non-synchronized method.

2. Related Art

Dramatic advances in computer technology presently make it possible to integrate a significant amount of computing power onto “smart cards.” Smart cards are presently used in a variety of applications that solve common security and identity needs. For example, smart cards have been integrated into credit cards, debit cards, corporate badges, and even cell phones.

New smart card designs can accommodate larger amounts of memory. For example, new smart card designs can accommodate up to 160K bytes of read-only memory (ROM), 64K bytes of electrically erasable programmable read-only memory (EEPROM), and 8K bytes of random access memory (RAM). These larger amounts of memory make it possible to integrate more functionality into a smart card.

In particular, the additional memory can be used to implement a virtual machine, such as the JAVA™ virtual machine (JVM), in a smart card, and to allow the use of objects defined within an object-oriented programming system. (JAVA is a trademark of SUN Microsystems, Inc. of Santa Clara, Calif.) Integrating a virtual machine into a smart card enables the smart card execute a large number of platform-independent applications. Moreover, the associated development environment for the virtual machine can simplify the process of developing applications for smart cards.

While it is possible to implement a virtual machine on one of these smart cards, the memory is still quite limited compared to a typical desktop computer system. This limited memory leads to many challenges in the implementing a virtual machine.

One problem is that programming languages, such as JAVA and corresponding JAVA bytecodes, are often unnecessarily complicated, which leads to unnecessary complexity in the virtual machine. In particular, the JAVA programming language (and corresponding JAVA bytecodes) provide support for synchronized methods. A synchronized method is a method that automatically performs a lock operation before executing its method body and automatically performs an unlock operation after executing its method body. This ensures that at most one thread at a time can execute the method body.

In order to provide this functionality, the virtual machine must ensure that a call to a synchronized method performs a lock operation, and that a corresponding return from the synchronized method automatically performs an unlock operation. Additionally, if an exception takes place within the synchronized method, the virtual machine must ensure that the synchronized method releases the lock before rethrowing the exception.

Including such functionality within a virtual machine increases the complexity of the virtual machine. Moreover, this increased complexity is largely unnecessary because the same functionality can be achieved by inserting explicit lock and unlock calls into the program instead of calling a synchronized method.

Note that it is possible to simply design a system that does not support synchronized methods. However, such a system would not be compatible with the large existing base of platform-independent applications that make calls to such synchronized methods.

Hence, what is needed is a method and an apparatus that facilitates running platform-independent applications that make calls to synchronized methods without the attendant complexity of implementing the synchronized methods within a virtual machine.

### SUMMARY

One embodiment of the present invention provides a system that facilitates converting a synchronized method into a non-synchronized method. During operation, the system receives a code module that includes a synchronized method. This synchronized method automatically performs a lock operation before executing its method body and automatically performs an unlock operation after executing its method body, whereby at most one thread at a time can execute the method body. Next, the system changes the synchronized method into a non-synchronized method that does not automatically perform lock and unlock operations. The system also inserts an explicit lock instruction at the beginning of the method body, and inserts an explicit unlock instruction at the end of the method body.

In a variation on this embodiment, the system additionally adds a new exception handler to the method. This new exception handler releases the lock when an exception is thrown within the method body. After releasing the lock, the new exception handler calls an existing exception hander.

In a variation on this embodiment, the lock is a monitor. In this variation, performing the lock operation involves performing a monitor enter operation, and performing the unlock operation involves performing a monitor exit operation.

In a variation on this embodiment, changing the synchronized method into a non-synchronized method involves modifying an attribute of the synchronized method to change the synchronized method into a non-synchronized method.

In a variation on this embodiment, the code module is a class file.

In a variation on this embodiment, the conversion process takes place within a translator that translates one or more class files into a suite file that is suitable for execution on a smart card.

In a variation on this embodiment, the code module contains platform-independent bytecodes, and the conversion process involves modifying the platform-independent bytecodes.

In a variation on this embodiment, the code module contains source code instructions specified in a high-level programming language, and the conversion process involves modifying the source code instructions.

In a variation on this embodiment, the synchronized method can be a static method or a virtual method.

### BRIEF DESCRIPTION OF THE FIGURES

FIG. 1 illustrates a smart card in accordance with an embodiment of the present invention.

FIG. 2 illustrates how class files are executed on a virtual machine within a smart card in accordance with an embodiment of the present invention.

FIG. 3 presents a flow chart illustrating the process of converting a synchronized method into a non-synchronized method in accordance with an embodiment of the present invention.

Table 1 illustrates a bytecode version of a virtual synchronized method in accordance with an embodiment of the present invention.

Table 2 illustrates a bytecode version of a corresponding non-synchronized method in accordance with an embodiment of the present invention.

Table 3 illustrates a bytecode version of a static synchronized method in accordance with an embodiment of the present invention.

Table 4 illustrates a bytecode version of a corresponding non-synchronized method in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Smart Card

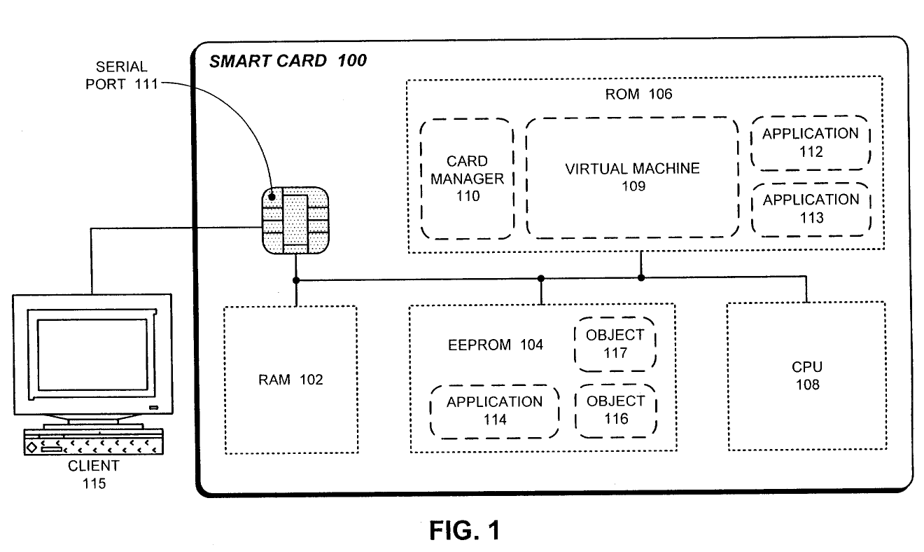

FIG. 1 illustrates a smart card in accordance with an embodiment of the present invention. Smart card 100 can generally include any type of miniature computing device, such as may be located within identification cards, client loyalty cards, electronic wallets, data cards and cellular telephones. However, note that the present invention is not meant to be limited to smart cards, and can generally be applied to any type of computing device or computer system that provides support for synchronized methods.

Smart card 100 contains a central processing unit (CPU) 108, which includes circuitry for performing computational operations. Smart card 100 also contains a number of different types of memory, including random access memory (RAM) 102, electrically erasable programmable read-only memory (EEPROM) 104 and read-only memory (ROM) 106.

In general, RAM 102 can include any type of volatile random access memory; EEPROM 104 can include any type of writeable non-volatile memory, such as EEPROM, flash memory, or magnetic memory; and ROM 106 can include any type of read-only memory.

ROM 106 contains a virtual machine 109, such as the JAVA virtual machine developed by SUN Microsystems, Inc. of Santa Clara, Calif. Note that applications written in a platform-independent programming language, such as the JAVA programming language, can be compiled into corresponding platform-independent bytecodes that can be executed on virtual machine 109.

ROM 106 also contains a number of applications, 112 and 113, which provide services for client 115, which accesses smart card 100 through serial port 111. Other applications, such as application 114, can be located in EEPROM 104. Yet other applications (not illustrated) may be located in both ROM 106 and EEPROM 104.

ROM 106 also includes a card manager 110, which manages the execution of applications on smart card 100. For example, suppose client 115 wishes to access a service provided by applications 112 on smart card 100. Client 115 first communicates with card manager 110. Card manager 110 then puts client 115 in contact with application 112. This allows client 115 to communicate directly with application 112.

EEPROM 104 also contains a number of objects 116-117, which are accessed by applications 112-114. Note that some objects or portions of objects may be located within RAM 102.

Executing Class Files on a Smart Card Virtual Machine

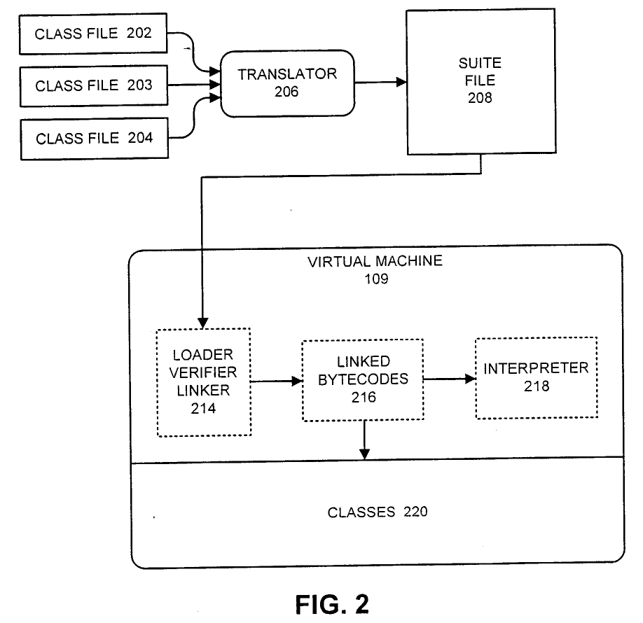

FIG. 2 illustrates how class files are executed on virtual machine 108 within smart card 100 in accordance with an embodiment of the present invention. In FIG. 2, a number of class files 202-204 (or other types of code modules) are converted by a translator 206 into a suite file 208, which is suitable for execution on virtual machine 109 within smart card 100. Note that this conversion process can take place at a workstation or some other type of computer system that is external to smart card 100.

A number of operations are involved in executing suite file 208 on virtual machine 109. Suite file 208 is first loaded into smart card 100. Next, linker/loader/verifier 214 loads and verifies classes from class files 202-204 and then binds them to library classes 220 within virtual machine 109. This produces linked bytecodes 216. Linked bytecodes 216 are then fed into interpreter 218, which interprets linked bytecodes 216 in order to execute them on virtual machine 109.

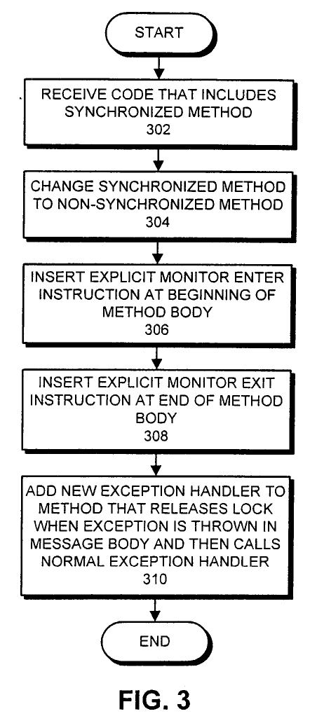

During the process of translating class files 202-204 into suite file 208 a number of operations take place. One of these operations converts synchronized methods within class files 202-204 into non-synchronized methods in suite file 208 as is described in more below with reference to FIG. 3.

Converting a Synchronized Method into a Non-Synchronized Method

FIG. 3 presents a flow chart illustrating the process of converting a synchronized method into a non-synchronized method in accordance with an embodiment of the present invention.

The system starts by receiving code that includes a synchronized method (step 302).

The system then converts the synchronized method into a corresponding equivalent non-synchronized method. This involves modifying an attribute of the synchronized method to change the synchronized method into a non-synchronized method (step 304). It also involves inserting an explicit monitor enter instruction at the beginning of the method body (step 306), and inserting an explicit monitor entry instruction at the end of the method body (step 308).

The system also adds a new exception handler to the method. This new exception handler releases the monitor when an exception is thrown in the method body and then rethrows the exception (step 310).

Note that the present invention operates at the bytecode level and converts a synchronized method in bytecode form into a corresponding non-synchronized method in bytecode form. Another embodiment of the present invention operates at the source code level and converts a source code version of a synchronized method into a corresponding source code version of a non-synchronized method.

### EXAMPLE

Note that the present invention can be applied to both static methods and virtual methods. For example in the virtual case, consider the following method.

synchronized void foo( ) {

System.out.println(“Hello World”);

}

This synchronized method can be compiled into the corresponding bytecode representation that appears below in Table 1.

TABLE 1

| | |
|---|---|
| Class: | Test |
| Method: | foo() |
| Access: | ACC-SYNCHRONIZED |

```
Body:
    0: getstatic <Field java.io.Printstream out>
    3: ldc <String “Hello World”>
    5: invokevirtual <Method void println(java.lang.String)>
    8: return
Exception Table:
```

One embodiment of the present invention translates this synchronized method into the functionally equivalent non-synchronized method that appears in Table 2.

TABLE 2

| | |
|---|---|
| Class: | Test |
| Method: | foo() |
| Access: | Nothing |

```
Body:
    0: aload_0
    1: monitorenter
    2: getstatic <Field java.io.Printstream out>
    5: ldc <String “Hello World”>
    7: invokevirtual <Method void println(java.lang.String)>
  10: aload_0
  11: monitorexit
  12: return
  13: astore_1
  14: aload_0
  15: monitorexit
  16: aload_1
  17: athrow
Exception Table:
```

| | | | |
|---|---|---|---|
| From | to | target | type |
| 2 | 12 | 13 | any |

Note that this non-synchronized method includes a monitorenter (at 1) and a monitorexit (at 11). It also includes a new exception handler (at 13-17), which performs a monitorexit and then rethrows the exception.

In the static case, consider the equivalent method.

synchronized static void foo( ) {

System.out.println(“Hello World”);

}

This synchronized method can be compiled into the corresponding bytecode representation that appears below in Table 3.

TABLE 3

| | |
|---|---|
| Class: | Test |
| Method: | foo() |
| Access: | ACC_STATIC ACC-SYNCHRONIZED |

```
Body:
    0: getstatic <Field java.io.Printstream out>
    3: ldc <String “Hello World”>
    5: invokevirtual <Method void println(java.lang.String)>
    8: return
Exception Table:
```

One embodiment of the present invention translates this synchronized method into the functionally equivalent non-synchronized method that appears in Table 4.

Note that getclass bytecode that appears in Table 4 is a not a standard JAVA bytecode. This getclass bytecode finds the object that represents the class of which the method is member and pushed it onto the stack.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not

TABLE 4

| | |
|---|---|
| Class: | Test |
| Method: | foo() |
| Access: | ACC_STATIC |

```
Body:
    0: getclass
    1: monitorenter
    2: getstatic <Field java.io.Printstream out>
    5: ldc <String “Hello World”>
    7: invokevirtual <Method void println(java.lang.String)>
  10: getclass
  11: monitorexit
  12: return
  13: astore_0
  14: getclass
  15: monitorexit
  16: aload_0
  17: athrow
Exception Table:
```

| | | | |
|---|---|---|---|
| From | to | target | type |
| 2 | 12 | 13 | any |

intended to limit the present invention. The scope of the present invention is defined by the appended claims.

What is claimed is:

1. A method for converting a synchronized method into a non-synchronized method, comprising:
receiving a code module that includes the synchronized method, wherein the synchronized method automatically performs a lock operation before executing the method body and automatically performs an unlock operation after executing the method body, whereby at most one thread at a time can execute the method body;
changing the synchronized method into a non-synchronized method that does not automatically perform lock and unlock operations;
inserting an explicit lock instruction at the beginning of the method body; and
inserting an explicit unlock instruction at the end of the method body.

2. The method of claim 1, further comprising adding a new exception handler to the method, wherein the new exception handler releases the lock when an exception is thrown within the method body.

3. The method of claim 2, wherein the new exception handler calls an existing exception hander after releasing the lock.

4. The method of claim 1,
wherein the lock is a monitor;
wherein performing the lock operation involves performing a monitor enter operation; and
wherein performing the unlock operation involves performing a monitor exit operation.

5. The method of claim 1, wherein changing the synchronized method into a non-synchronized method involves modifying an attribute of the synchronized method to change the synchronized method into a non-synchronized method.

6. The method of claim 1, wherein the code module is a class file.

7. The method of claim 1, wherein the conversion process takes place within a translator that translates one or more class files into a suite file that is suitable for execution on a smart card.

8. The method of claim 1, wherein the code module contains platform-independent bytecodes, and wherein the conversion process involves modifying the platform-independent bytecodes.

9. The method of claim 1, wherein the code module contains source code instructions specified in a high-level programming language, and wherein the conversion process involves modifying the source code instructions.

10. The method of claim 1, wherein the synchronized method can be a static method or a virtual method.

11. A computer-readable storage medium storing instructions that when executed by a computer cause the computer to perform a method for converting a synchronized method into a non-synchronized method, the method comprising:
receiving a code module that includes the synchronized method, wherein the synchronized method automatically performs a lock operation before executing the method body and automatically performs an unlock operation after executing the method body, whereby at most one thread at a time can execute the method body;
changing the synchronized method into a non-synchronized method that does not automatically perform lock and unlock operations;
inserting an explicit lock instruction at the beginning of the method body; and
inserting an explicit unlock instruction at the end of the method body.

12. The computer-readable storage medium of claim 11, wherein the method further comprises adding a new exception handler to the method, wherein the new exception handler releases the lock when an exception is thrown within the method body.

13. The computer-readable storage medium of claim 12, wherein the new exception handler calls an existing exception hander after releasing the lock.

14. The computer-readable storage medium of claim 11,
wherein the lock is a monitor;
wherein performing the lock operation involves performing a monitor enter operation; and
wherein performing the unlock operation involves performing a monitor exit operation.

15. The computer-readable storage medium of claim 11, wherein changing the synchronized method into a non-synchronized method involves modifying an attribute of the synchronized method to change the synchronized method into a non-synchronized method.

16. The computer-readable storage medium of claim 11, wherein the code module is a class file.

17. The computer-readable storage medium of claim 11, wherein the conversion process takes place within a translator that translates one or more class files into a suite file that is suitable for execution on a smart card.

18. The computer-readable storage medium of claim 11, wherein the code module contains platform-independent bytecodes, and wherein the conversion process involves modifying the platform-independent bytecodes.

19. The computer-readable storage medium of claim 11, wherein the code module contains source code instructions specified in a high-level programming language, and wherein the conversion process involves modifying the source code instructions.

20. The computer-readable storage medium of claim 11, wherein the synchronized method can be a static method or a virtual method.

21. An apparatus that converts a synchronized method into a non-synchronized method, comprising:
a receiving mechanism configured to receive a code module that includes the synchronized method, wherein the synchronized method automatically performs a lock operation before executing the method body and automatically performs an unlock operation after executing the method body, whereby at most one thread at a time can execute the method body; and
a conversion mechanism configured to,
change the synchronized method into a non-synchronized method that does not automatically perform lock and unlock operations,
insert an explicit lock instruction at the beginning of the method body, and to
insert an explicit unlock instruction at the end of the method body.

22. The apparatus of claim 21, wherein the conversion mechanism is configured to add a new exception handler to the method, wherein the new exception handler releases the lock when an exception is thrown within the method body.

23. The apparatus of claim 22, wherein the new exception handler calls an existing exception hander after releasing the lock.

24. The apparatus of claim 21,
wherein the lock is a monitor;
wherein performing the lock operation involves performing a monitor enter operation; and
wherein performing the unlock operation involves performing a monitor exit operation.

25. The apparatus of claim 21, wherein the conversion mechanism is configured to change the synchronized method into a non-synchronized method by modifying an attribute of the synchronized method to change the synchronized method into a non-synchronized method.

26. The apparatus of claim 21, wherein the code module is a class file.

27. The apparatus of claim 21, wherein the apparatus is located within a translator that translates one or more class files into a suite file that is suitable for execution on a smart card.

28. The apparatus of claim 21, wherein the code module contains platform-independent bytecodes, and wherein the conversion mechanism is configured to modify the platform-independent bytecodes.

29. The apparatus of claim 21, wherein the code module contains source code instructions specified in a high-level programming language, and wherein the conversion mechanism is configured to modify the source code instructions.

30. The apparatus of claim 21, wherein the synchronized method can be a static method or a virtual method.
